(19) United States
(12) Patent Application Publication
(10) Pub. No.: US 2004/0095392 A1
(43) Pub. Date: May 20, 2004

(54) Method and system for generating portal pages

(76) Inventor: Motoharu Sato, Yokohama (JP)

Correspondence Address: MATTINGLY, STANGER & MALUR, P.C., ATTORNEYS AT LAW, SUITE 370, 1800 DIAGONAL ROAD, ALEXANDRIA, VA, 22314, US

(21) Appl. No.: 10/634,791

(22) Filed: Aug. 6, 2003

(30) Foreign Application Priority Data
Aug. 8, 2002 (JP) 2002-231957

(51) Int. Cl. G09G 5/00

(52) U.S. Cl. 345/772; 345/629; 345/733

(57) ABSTRACT

A content generating section generates contents. The busy content is recorded by use of the busy contents list. A content list controlling section updates the content of the busy contents list based on the measured busyness. A portal entry image generation system comprises an entry image synthesizing section for generating the busy content based on the busy contents list. The information of busy content is registered in the busy contents list corresponding to the measured result. This content is synthesized preferentially, and a portal entry image is generated. On the other hand, the non-busy content is not synthesized and generation for display is omitted. As the result, the time is shortened as a whole.

### BACKGROUND OF THE INVENTION

1. Field of the Invention

This invention relates to a method and a system for generating portal entry images, and more particularly relates to a method and a system for generating portal entry images by synthesizing one image from a plurality of contents to provide the contents to a website through a network.

2. Description of the Related Art

Network systems such as Internet and intranet have been used to access to the target website from a web page, and a user obtain necessary contents daily. A user usually uses a plurality of contents successively or simultaneously. For convenience, various indicators or contents used for connecting to a plurality of websites are displayed on the first web page that is the entry point for the user, and the user can access to the system of each site from these contents.

Japanese Published Unexamined Patent Application No. 2001-256184 (corresponding U.S. Application Priority Assertion No. 60/173,844 (1999.12.30), Ser. No. 09/611,460 (2000.7.7)) discloses a method in which contents are displayed on one entry image to make access easier to the information and service distributed in an organization. Such image is called as portal entry image.

### SUMMARY OF THE INVENTION

A plurality of contents that relate to a plurality of system is displayed on a portal entry image generally. For example, a plurality of images including E-mail image, attendance system image, air-ticket train-ticket purchase application image, electronic voting system image, and news image is displayed synthetically on an entry image of a user in some cases. In such cases, many users access intensively to a specific content temporarily in comparison with other contents. Such intensive access may occur, for example, in closing day of an attendance system, application day of a ticket application system, just after acceptance starting time of an electronic voting system, or just after news reporting of a severe disaster or accident.

According to the conventional technique disclosed in the abovementioned patent application, all the contents are still displayed on a portal entry image even when many users access intensively to a specific content, all the contents that relate to respective systems are synthesized to form a portal entry image. It is sufficient for many users who want to access to the specific content being accessed intensively that the specific content is displayed on a portal entry image. However, according to the conventional technique, the contents that many users do not want to get now is used to synthesize the portal entry image, as the result it requires a long time to generate and synthesize the portal entry image, and a user must wait for completion of entry image forming.

An object of the present invention is to provide a method and a system for generating portal images in which the display of a portal image is changed so that a user can use it conveniently.

Another object of the present invention is to provide a method and a system for generating portal entry images that preferentially display a content being accessed intensively (referred to as busy content hereinafter). Yet another object of the present invention is to provide a method and a system for generating portal entry images that are capable of shortening the time required for displaying a portal entry image by omitting generation of some entry images that are unnecessary to be displayed.

To accomplish the abovementioned objects, the system of the present invention is provided with a server connected to a plurality of systems for generating a content for generating a portal entry image to provide the content of the system to a browser through a network, wherein the system is provided with a memory means for storing the information of the content, a controlling section for updating the content of the memory means based on the busyness information transmitted from the system, and an entry image synthesizing section for synthesizing the busy content preferentially based on the memory content of the memory means to generate a portal entry image.

In a preferred embodiment, each of the plurality of systems is provided with a monitor for measuring the popularity, and the server is provided with a busy contents list for recording the busy content, and a content list controlling section for updating the content of the busy contents list based on the information of the busyness measured by means of the monitor, and an entry image synthesizing section synthesizes the busy content preferentially according to the content of the busy contents list to generate a portal entry image.

In the preferred embodiment, the popular content is displayed preferentially so that a user can use it conveniently. For example, the entry image synthesizing section synthesizes and generates an image so that the busy content is displayed larger than other contents. Furthermore, a portal entry image is generated so that a plurality of contents are arranged in the order of busyness for convenient use of the portal entry image.

Furthermore, the entry image synthesizing section does not use the content of low busyness for synthesis. The entry image synthesizing section omits generation of the entry image that is unnecessary for a user, and as the result the time for displaying the portal entry image is shortened.

According to another embodiment, the server is provided with a registration content list for registering the layout of the portal entry image including a content displayed in a predetermined time period, a current content list for recording the layout of the portal entry image that is used currently, an entry image synthesizing section for generating a predetermined content based on the current content list, and a content list controlling section for updating the current content list based on the timer time. Particularly, if the intensive access to a specific content on a portal entry image is predicted, a portal entry image that is different from the normal display mode image is displayed during the time period while many users are accessing intensively so that the busy content is displayed preferentially.

In yet another embodiment, the system is provided with a user authenticating section for specifying a user of a portal entry image, a busy contents list for recording the minimum access frequency that records the minimum access frequency for displaying the content on the portal entry image for each system, the accumulated access frequency for recording access frequency of the system for each user, and the busy content for each user, an access monitor for updating the accumulated access frequency value at every access of a user to acquire the accumulated access frequency value at certain time intervals, a content list controlling section for updating the content of the busy contents list based on the busyness acquired by means of the access monitor, and an entry image synthesizing section for synthesizing a busy content based on the busy contents list. According to the above, the access frequency of each content on the portal entry image is measured for each user, contents are arranged in the order of access frequency from the top, and the portal entry image is synthesized so as not to include contents of less access frequency.

A method for generating a portal entry image in accordance with the present invention comprises the first mode for obtaining related contents to be displayed from a plurality of systems connected to a network to generate the first image including a plurality of contents, the second mode for generating the second image including busy contents the number of which is less than that of contents displayed in the first image wherein any content corresponds to a system selected from among the plurality of systems, a step for switching between the first mode and the second mode depending on the information related to the busyness of the contents of the plurality of systems, and a step for transmitting the first image or the second image to the network.

In preferred embodiments, each system monitors the busyness of the content provided by the system and changes the content to be included in the second image depending on the monitoring result. The second image is generated so that the content of a high busyness system is displayed larger than other contents of low busyness systems. A link for changing from the second image to the first image is displayed on the second image for easy changing from the second mode to the first mode. These functions allow generation of a user-friendly a portal entry image easily.

The information related to busyness of the content can be obtained by means of various methods. In a preferred embodiment, the busyness of the content is obtained from the measured result of the number of connections stringed between each system. In another preferred embodiment, the busyness of the content is obtained based on the number of requests for acquiring the content to each system. In yet another embodiment, the busyness of the content is obtained from the number of operations operated when the portal entry image is operated to obtain the content. The method is by no means limited to the abovementioned embodiments, and any method in which the use frequency of a user actually reflects the access frequency may be used.

### BRIEF DESCRIPTION OF THE DRAWINGS

FIG. 1 is a block diagram showing the configuration of a portal entry image generating system in accordance with one embodiment of the present invention;

FIG. 2 is a diagram showing one exemplary portal entry image on which contents of all the system are displayed;

FIG. 3 is a diagram showing one exemplary portal entry image on which only contents of selected partial systems are displayed;

FIG. 4 is a flowchart showing a portal entry image generation flow;

FIG. 5 is a flowchart showing a process flow of portal entry image generation system operated when the access frequency from a certain system increases;

FIG. 6 is a diagram showing a busy contents list on which contents are arranged in the order of busyness on a portal entry image in accordance with one embodiment of the present invention;

FIG. 7 is a diagram showing an exemplary portal entry image on which contents having different sizes that are proportional to the busyness are displayed;

FIG. 8 is a block diagram showing a portal entry image generation system in accordance with another embodiment of the present invention;

FIG. 9 is a flowchart showing a process flow for changing the portal entry image configuration in another embodiment;

FIG. 10 is a block structural diagram of a portal entry image generation system used for changing the portal entry image configuration in accordance with another embodiment of the present invention; and

FIG. 11 is a flowchart showing an update process flow of a busy contents list.

### DESCRIPTION OF THE PREFERRED EMBODIMENTS

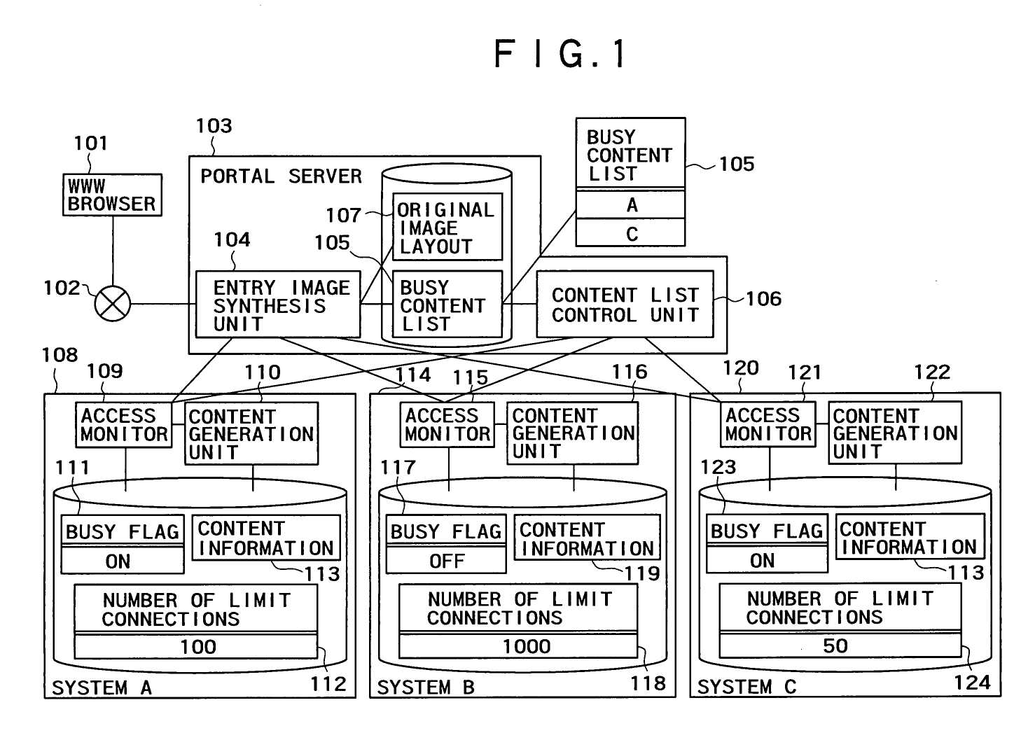

Embodiments of the present invention will be described in detail hereinafter with reference to the drawings. FIG. 1 is a block diagram showing the configuration of a portal entry image generation system in accordance with one embodiment of the present invention. In this embodiment, a portal entry image configuration is changed exemplarily corresponding to the busyness of a content.

In FIG. 1, a portal server 103 that plays a main part for generating a portal entry image is connected to a WWW browser 101 through a network 102, and connected to a plurality of systems 108, 114, and 120 (represented as 108 hereinafter) that provide contents. The network is a communication network such as Internet, intranet, LAN, and WAN.

The portal entry image configuration is changed corresponding to the busyness of a content in this embodiment, wherein the busyness is measured by measuring the number of connections stringed between each system 108 and the portal server 103. In other words, “the busyness is determined to be high” if the number of connections to a certain system is larger than the predetermined number of connections. As a matter of course, the determining method is by no means limited to the abovementioned method, and another method may be used for determining the busyness. For example, the number of content acquisition requests from the portal server 103 to each system 108 may be measured, or the number of operations on a content in a portal entry image may be measured. Each system 108 counts the number of requests for acquiring the content from a user to thereby obtain the number of content acquisition requests. Each system 108 side or server 103 counts and accumulates in memory the number of clicking by a user on the content display image to thereby obtain the number of operations on the content.

The portal server 103 comprises an entry image synthesizing section 104, a busy contents list 105, a content list controlling section 106, and an original image layout 107. The entry image synthesizing section 104 is connected to the plurality of systems 108, 114, and 120.

The busy contents list 105 is a means for storing the content of busy system, and stores an identifier of the system having a content that is to be displayed on the current portal entry image among systems connected to the portal server 103. The style of the busy contents list 105 is arbitrary, and may be the table style or file style. In FIG. 1, the busy contents list 105, that is shown with a lead line drawn toward upper-right direction, lists registered identifiers of contents in the system A and system C as the busy content so as to show the detail of the content of the list 105.

The content list controlling section 106 updates the content of the busy contents list 105 based on the information transmitted from access monitors 109, 115, and 121. In detail, when the access monitor of a certain system determines that the busyness of the content exceeds a predetermined value, the content list controlling section 106 adds and resisters the identifier of the system in the busy contents list 105 to thereby preferentially display the content on the entry image. On the other hand, when the busyness falls down exceeding the predetermined value, the content list controlling section 106 controls so that the identifier is deleted from the list 105. The detailed operation of the content list controlling section 106 will be described later.

The original image layout 107 is formed in file style or table style for registering the position information and size information of each content on the usual portal entry image. The content image synthesized on the portal entry image is generated based on the position information and size information.

The systems 108, 114, and 120 are provided with respective information processors and databases. The information processors are provided with the function of respective access monitors 109, 115, and 121, and content generating sections 110, 116, 122. The databases are provided with the function for storing respective busy flags 111, 117, and 123, and the numbers of limit connections 112, 118, and 124, and content information 113, 119, and 125. The content information 113, 119, and 125 is the information for holding the internal information of the system like a mail reception box.

The content generating sections 108, 112, and 116 form structural elements 202, 203, and 204 of images to be displayed on the portal entry image 201 based on the content information 113, 119, and 125, and transmit the elements to the entry image synthesizing section 104 of the portal server 103. The numbers of limit connections 112, 118, and 124 are values that are set when the systems are structured depending on the processing content and processing capacity of the systems. The limit value for determining high load on a system is set as the number of connections for content acquisition request stringed between the portal sever 103 and the systems. The access monitors 109, 115, and 121 monitor the number of connections for content generation request stringed between the portal server 103 and the systems. If the numbers of connections 112, 118, and 124 exceed the numbers of limit connections 112, 118, and 124, the busy flags 111, 117, and 123 are updated, and then the content list controlling section 106 is informed of the fact. The busy flags 111, 117, and 123 are places for storing information that indicates whether the numbers of connections between the portal server 103 and the systems exceed the numbers of limit connections 112, 118, and 124 or not, and the busy flag takes a value of ON or OFF. In the situation shown in FIG. 1, the number of connections between the portal server 103 and the system 108 exceeds the number of limit connections of the system 108, namely 100, and as the result the busy flag 111 of the system 108 is ON. Similarly, the number of connections between the portal server 103 and the system 120 exceeds the number of limit connections 124 of the system 120, namely 50. Hence, respective identifiers A and B of the system 108 and system 120 are registered in the busy contents list 105. The above-mentioned number of limit connections is used as the standard value for determining the busyness, and is not necessarily a fixed value but may be a variable value depending on the case. For example, the number of connections of a WWW system content for mail-order sale of a loss leader is set to be small on the date of issue of the loss leader, and the number is changed to be larger after several days from the date of issue. If the number of limit connections is changed to a small value just after the date of issue, the monitored number of connections exceeds the small number of limit connections very soon, and the content is registered in the busy contents list 105. As the result the content of the merchandise becomes attractive.

The detailed operation of the whole system in which the number of connections monitored by the access monitor is changed will be described hereinafter.

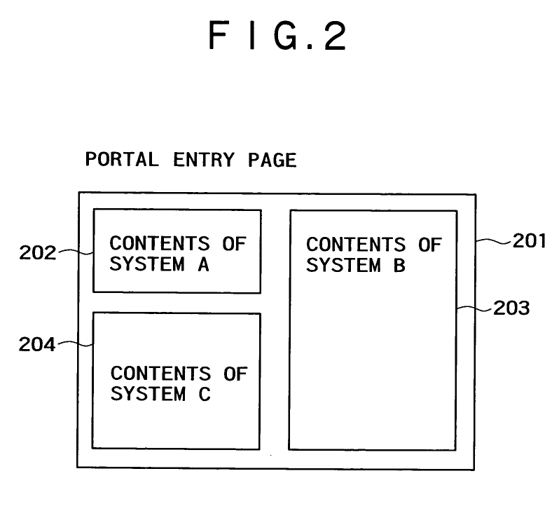

FIG. 2 is an exemplary portal entry image on which respective contents of all the systems are displayed. The contents 202, 203, and 204 of all the systems 108, 114, and 120 connected to the portal server 103 are displayed on the portal entry image 201. This image is an image that is displayed in so-called normal display mode and this image is called as the first image for description, and the mode in which the entry image synthesizing section 104 generates the first image is called as the first operation mode. The content and number to be displayed on the first image are determined depending on what system is supported and what content is synthesized when the portal server 103 is structured.

The busy contents list 105 does not include any registered identifier of a system and is blank in the first operation mode.

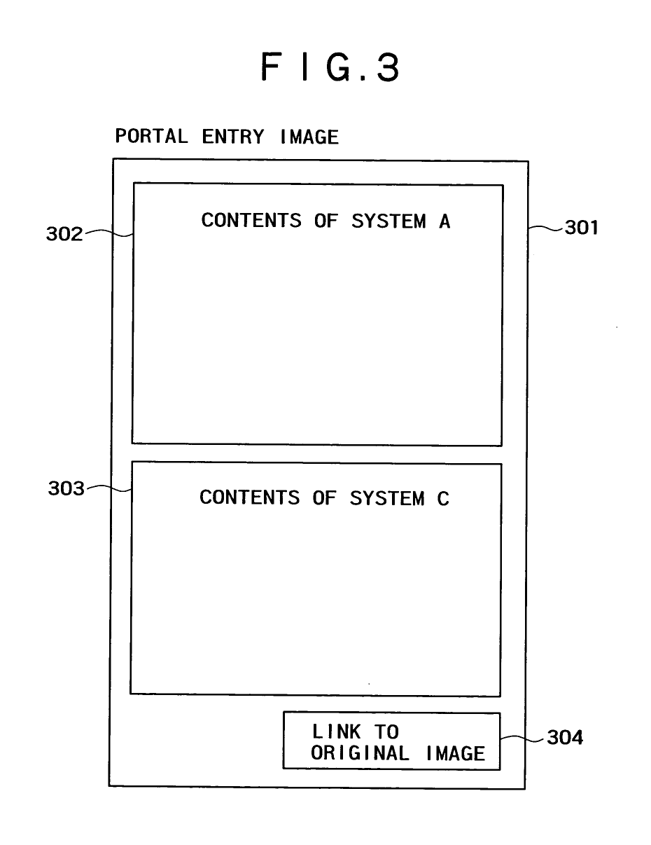

On the other hand, FIG. 3 is an exemplary portal entry image on which contents of partially selected systems are displayed. On the portal entry image 301, the content 302 of the system 108 and the content 303 of the system 120 are displayed, and a link 304 to the original image is displayed. In this case, the contents of the systems 108 and 120 are busy as shown in FIG. 1. The case in which this image is displayed indicates the display mode based on the busyness of a content. This image is called as the second image for description, and the case in which the second image is generated by the entry image synthesizing section 104 is called as the second operation mode.

At that time, the identifier A of the system 108 and the identifier C of the system 120 are registered in the busy contents list 105. In this exemplary image 301, the contents 301 and 303 are enlarged so as to match with the width of the portal entry image 201, and the contents 302 and 303 are arranged from the top of the image downward in the order of registration on the busy contents list 105. A method for synthesizing a image with controlling the layout and size of contents will be described in detail hereinafter.

The link 304 to the original image is provided to change the so-called second image 301 shown in FIG. 3 to the so-called first image 201 shown in FIG. 2. When a user contacts the link 304, the entry image synthesizing section 104 generates the portal entry image 201 that includes respective contents of all the systems according to the original image layout 107 and transmits the portal entry image 201 to the WWW browser. A user can access to the content 203 of the system 114 that has not been displayed on the image 301 by way of the image 201. The link 304 to the original image 201 is displayed on the portal entry image 301 in the present embodiment, but instead a link to the content 203 of the system 114 may be displayed on the bottom of the portal entry image 301 so that only the content 203 is displayed on the linked image. In this way, a user can also access to a content that is not displayed on the second image.

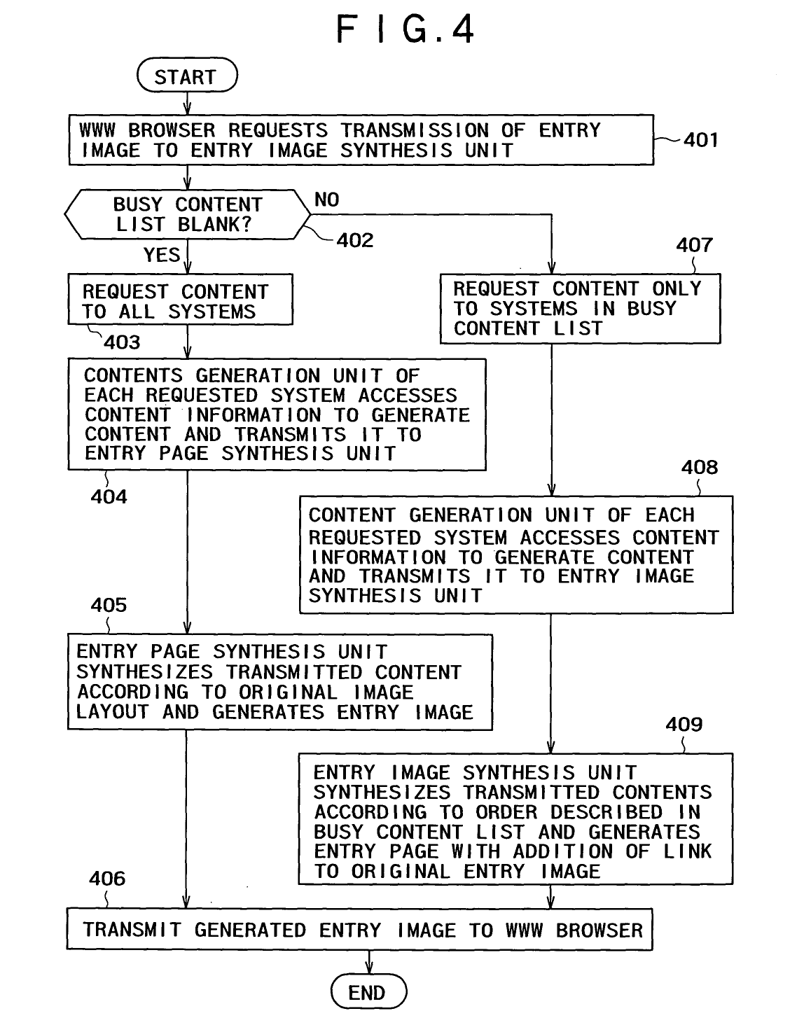

FIG. 4 is a diagram for describing a method for generating a portal entry image in this system.

The WWW browser 101 requests transmission of a portal entry image to the entry image synthesizing section 104 of the portal server 103 (step 401). The entry image synthesizing section 104 refers the content of the busy contents list 105. If the list is blank, namely in the normal display mode (first mode), the sequence proceeds to step 403. On the other hand, if the list is not blank, namely in the mode displayed corresponding to the busyness (second mode), the sequence proceeds to step 407 (step 402). In the first mode, the entry image synthesizing section 104 requests the content to all the systems connected to the portal server 103 (step 403). The content generating sections 110, 116, and 122 that receive the request from the entry image synthesizing section 104 generate contents to be displayed on the portal entry image and transmit them to the entry image synthesizing section 104 (step 404). The entry image synthesizing section 104 synthesizes the contents transmitted from the respective content generating sections of the systems according to the original image layout 107, and generates a portal entry image (step 405). The portal entry image generated in step 405 or step 409 is transmitted to the WWW browser 101 (step 406). The portal entry image generated in step 405, namely the first image, is transmitted to the WWW browser 101 (step 406).

On the other hand, if any identifier is registered in the busy contents list 105, the entry image synthesizing section 104 requests a content to the system having the identifier (step 407). A content generating section that received the request from the entry image synthesizing section 104, for example, the content generating section 110 of the system 108, generates a content to be displayed on the portal entry image and transmits the content to the entry image synthesizing section 104 (step 408). The system 120 also transmits a content to the entry image synthesizing section 104 similarly in the case shown in FIG. 1. The entry image synthesizing section 104 arranges the contents A and C transmitted from the content generating sections of the systems 108 and 120 in the order of registration in the busy contents list 105 (namely in the order as shown in FIG. 3), and generates the portal entry image 301 with addition of the link 304 to the original entry image (step 409). The entry image, namely the second image, generated as described hereinabove is transmitted to the WWW browser.

Various arrangements of the content to be displayed in generation of the second image are available. In the abovementioned embodiment, contents are registered in the busy contents list 105 in the order of registration after the contents are enlarged so that the width of the contents fits with the size of the whole image when the contents are arranged on the portal entry image. However, in another exemplary layout, the contents are arranged from the left to the right in the order of registration in the busy contents list 105 after the contents are enlarged so that, for example, the vertical length of the contents fits with the size of the whole image. In yet another exemplary layout, only the contents registered in the busy contents list 105 are arranged according to the original layout. According to this method, for example, only the content 203 is deleted from the first image 201, and the second image 301 is formed. In further yet another exemplary layout, the contents registered in the busy contents list 105 are arranged according to the original image layout, and then the space occupied by the content that is not registered in the busy contents list 105 is moved upward or in the left direction. If the vertical size or the horizontal size of the whole portal entry image that has been synthesized exceeds the image size of the WWW browser on which the portal entry image is displayed, the vertical scroll bar or horizontal scroll bar is displayed on the portal entry image by means of the function of the WWW browser as required.

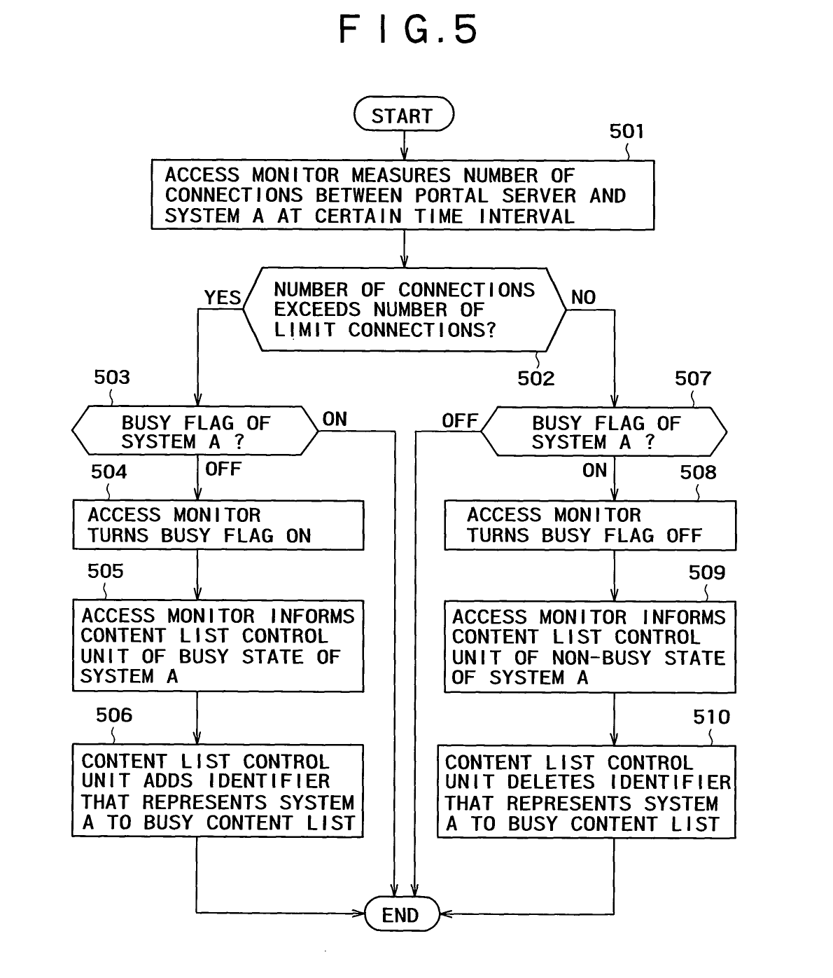

FIG. 5 is a diagram showing the relation between the increasing/decreasing of the number of accesses to the system and operation of the access monitors 109, 115, and 121. The operation of the access monitor 109 of the system 108 is described exemplarily.

The access monitor 109 measures the number of connections stringed between the portal server 103 and the system 108 for requesting the content at certain time intervals (step 501). The system manager has determined the certain time interval based on the increasing/decreasing cycle of using frequency of the system 108 in the past, and has set the time interval in the access monitor previously when the system was structured.

The measured number of connections is compared with the number of limit connections 112 that has been set in the system 108 previously. If the measured value exceeds the number of limit connections 112 as the result, the sequence proceeds to step 503. On the other hand, if the measured value does not exceed the number of limit connections 112, the sequence proceeds to step 507 (step 502).

At first, the case in which the measured value exceeds the number of limit connections is described hereunder. The access monitor 109 checks the busy flag 111. If the flag value is ON, the sequence goes to the end. If the flag value is OFF, the sequence proceeds to step 504 (step 503). The access monitor 109 of the system 108 turns the busy flag 111 ON (step 504). The access monitor 109 of the system 108 informs of the busy situation of the system 108 to the content list controlling section 106 (step 505). The content list controlling section 106 registers an identifier of the system 108 in the busy contents list 105 of the portal server 103 (step 506).

On the other hand, if the measured value does not exceeds the number of limit connections, the access monitor 109 checks the busy flag 111. If the flag is OFF as the result, the sequence goes to the end. If the flag is ON, the sequence proceeds to step 508 (step 507). The access monitor 109 of the system 108 turns the busy flag 111 OFF (step 508). The access monitor 109 of the system 108 informs of non-busy situation of the system 108 to the content list controlling section 106 (step 509). The content list controlling section 106 deletes the identifier of the system 108 from the busy contents list 105 (step 510).

According to the present invention, the invention may be changed and modified variously for easy viewing of busy contents and easy access to the busy contents. For example, the layout of contents is described in which contents of the systems are arranged on the portal entry image 301 in the order of registration in the busy contents list 105 in the case that the identifier of a system is registered in the busy contents list 105 in step 409 in the abovementioned embodiment. However, the layout is by no means limited to the abovementioned layout. For example, a layout may be employed in which contents are arranged on the portal entry image 301 in the order of busyness of the content from the top of the portal entry image for easy viewing of the high busyness content and for easy access to the high busyness content.

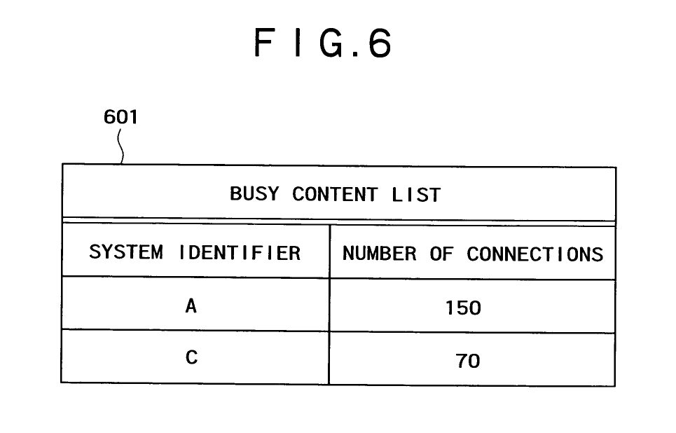

FIG. 6 is an exemplary busy contents list used for such embodiment. In this busy contents list, contents are arranged on the portal entry image in the order of busyness from the top of the portal entry image when a specific content is intensively busy.

In this case, the access monitor 109 informs of busy situation of the system 108 and the measured number of connections to the content list controlling section 106. In step 506, the content list controlling section 106 additionally registers the informed identifier of the system and number of connections so that system identifiers are arranged in the busy contents list 601 in the order of the number of connections from the largest on the top. In this embodiment, contents are arranged in the order of the number of connections, that is a busyness indicator, from the top or from the left side by use of the content arrangement on the portal entry image in step 409.

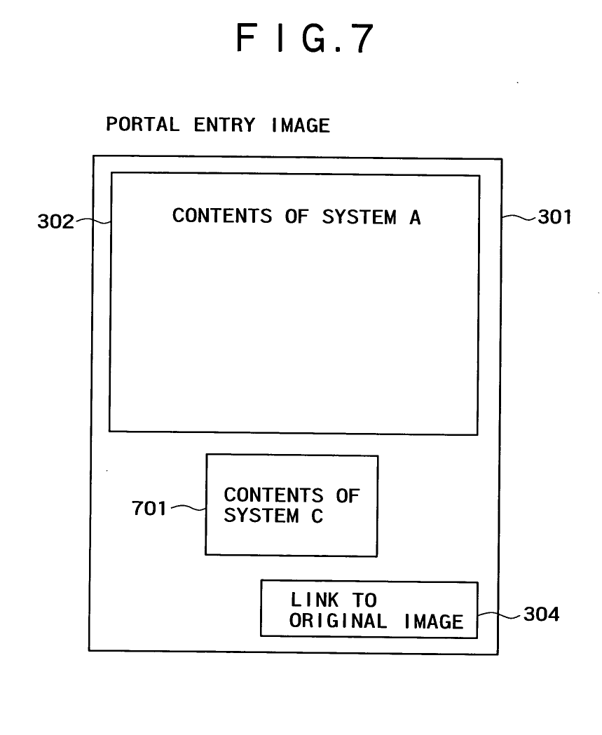

FIG. 7 is an exemplary portal entry image on which the size of contents is different depending on the proportion of the number of connections registered in the busy contents list 601. The size of contents is differentiated depending on the magnitude of the number of connections registered in the busy contents list 601, and then these contents are arranged on the portal entry image. The content with high busyness is displayed larger for easy use of the content as described hereinabove.

In detail, the content 302 of the system A is formed so that the width of the content 202 of the system A is enlarged to fit with the width of the portal entry image 201. The content 701 of the system C is formed by changing the width of the content 204 of the system C so that the width ratio of the content 701 to the content 302 of the system A is equal to the number of connection ratio in the busy contents list 601, and then the content of the system C is arranged under the content 302 of the system A with centering.

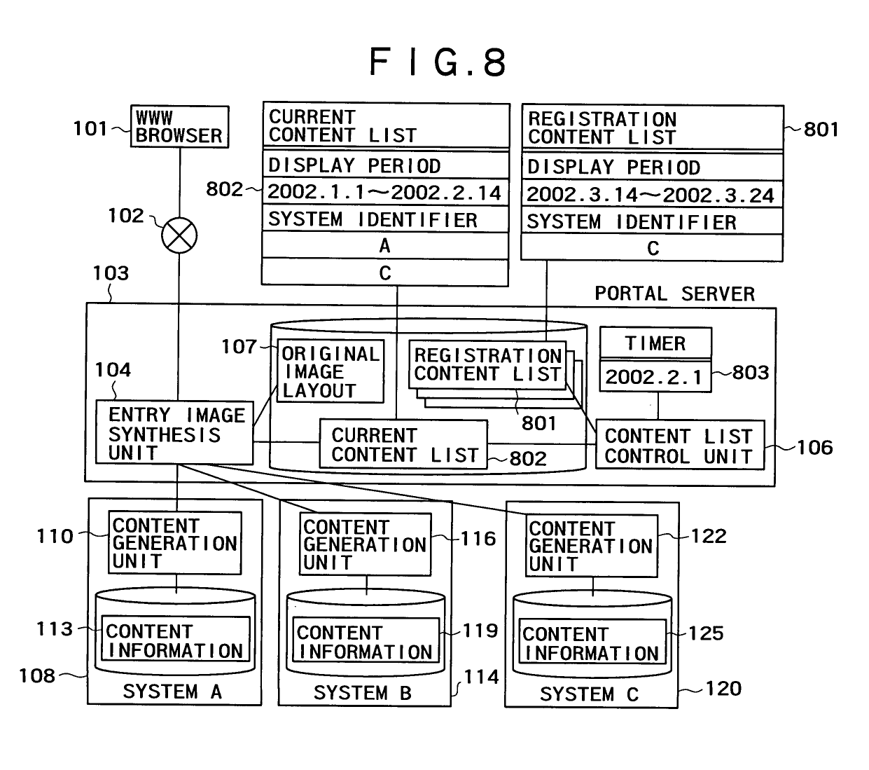

FIG. 8 is a block diagram showing a system for generating a portal entry image according to another embodiment for updating the layout of the portal entry image statically. In this embodiment, a plurality of portal entry images have been registered previously with the information for indicating the display period. The embodiment is provided with a registration content list 801 and a current content list 802 instead of the busy contents list 105 shown in FIG. 1. A timer 803 is connected to the content list controlling section 106. The registration content list 801 is a content list formed so that the display period is added to the busy contents list 105. In the above, the display period means the period during which the portal entry image layout having contents arranged in the order of the list is used. A system manager can register a plurality of periods in system structuring or operation to add the period. In the above, a plurality of content lists having display periods that overlap each other cannot be registered. The timer 803 informs of the current time to the content list controlling section 106 at certain time intervals. Content lists in the display period among the registration content lists 801 are transferred and registered in the current content list 802.

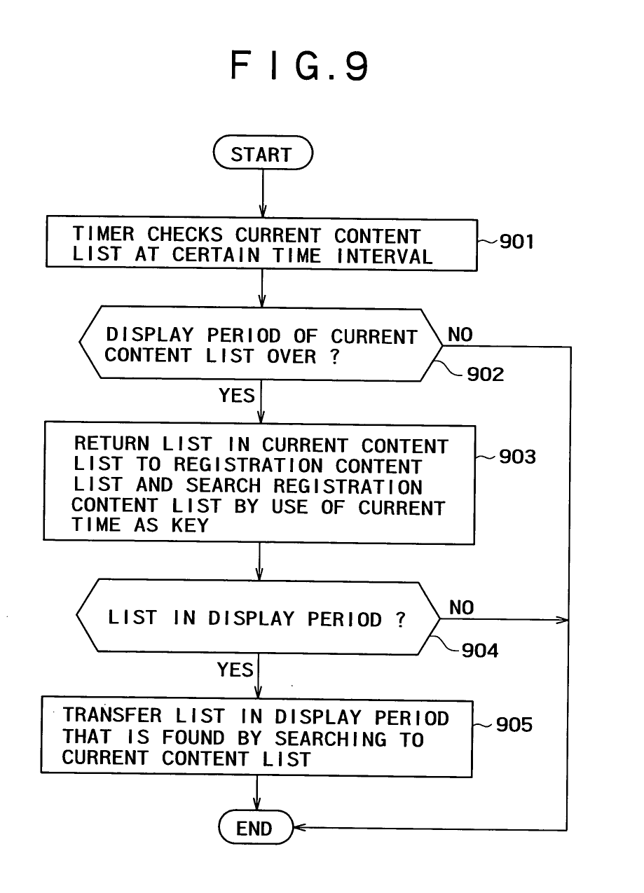

Operation of the content list controlling section 106 of the system shown in FIG. 8 is described with reference to FIG. 9. The content list controlling section 106 checks the content of the registration content list 801 at certain time intervals according to the signal supplied from the timer 803 (step 901).

If the display period of the current content list 802 is not over, the sequence goes to the end. If the display period is over, the sequence proceeds to step 903 (step 902). The list in the current content list 802 is returned to the registration content list 801, and the registration content list 801 is searched (step 903).

If there is no registration content list 801 in the display period, the sequence goes to the end. If there is any registration content list 801 in the display period, the sequence proceeds to step 905 (step 904). The registration content list 801 in the display period is transferred to the current content list 802 (step 905).

According to the abovementioned embodiment, synthesis of the content B is omitted during the time period that has been scheduled previously. As described hereinabove, the image layout is differentiated from that in the normal display mode during the time period in which many users predictably access to a specific content intensively on the portal entry image, and the content on the portal entry image is changed so that such busy access content is displayed preferentially to synthesize the portal entry image. As the result, generation time and synthesis time required for unnecessary content can be omitted.

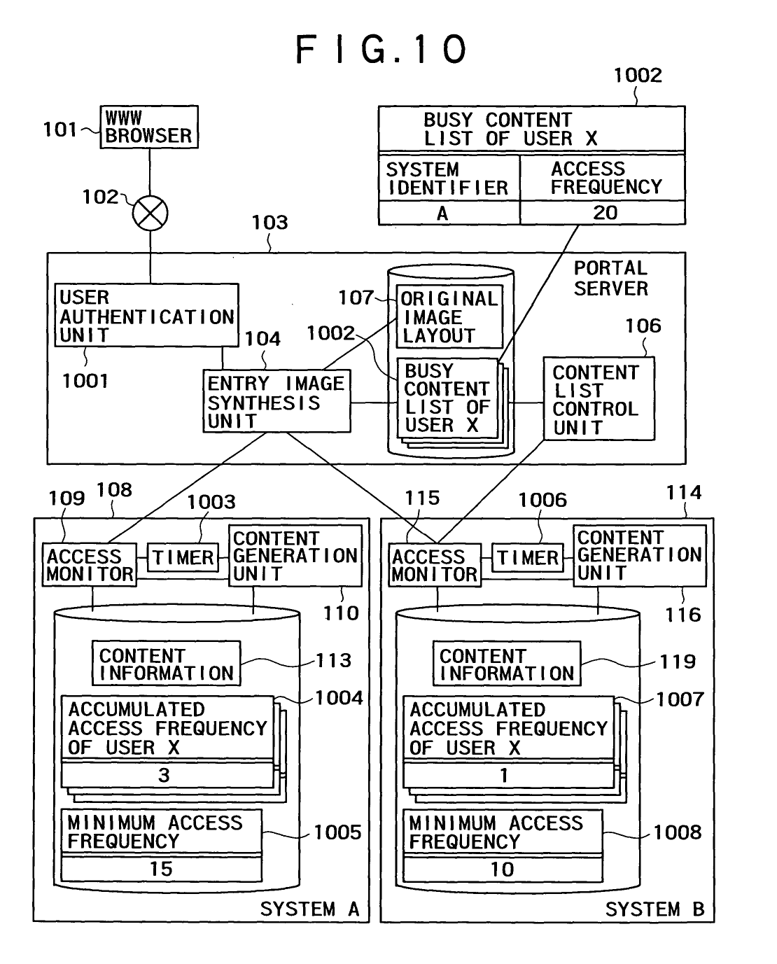

FIG. 10 is an exemplary system for changing the portal entry image configuration in accordance with yet another embodiment. In this embodiment, the access frequency to each content on the portal entry image is measured for each user, an portal entry image that is suitable for each user is generated according to the access frequency of each user. In this embodiment, the access frequency is measured in the form of accumulated access frequency in the preceding month. However, the accumulated access frequency during the arbitrary time period such as a day or a year may be used as the access frequency in the system structure. A user authenticating section 1001 is connected between a network 102 and an entry image synthesizing section 104 of a portal sever 103. The user authenticating section 1001 specifies a user who uses the portal entry image. In an exemplary method for authenticating a user, for example, an image on which an identifier of a user is to be input such as a login image is displayed before a portal entry image is displayed so as to prompt the user to input the identifier such as ID or password, and the identifier is checked to authenticate the user. Otherwise, in another method for authenticating a user, a corresponding table that describes corresponding relation between the identifier of a user and the position information of the WWW browser is prepared, and the identifier of the user is specified by means of the position information of the system that connects to the portal server 103.

The busy contents list 1002 is a list prepared for each user, and a plurality of pairs of the identifier of a system and access frequency is registered. The entry image synthesizing section 104 arranges corresponding contents in the registration order of the busy contents list 1002 from the top with adding a link to the original image to thereby configure a portal entry image. Furthermore, the entry image synthesizing section 104 informs of the identifier of a user who is specified by the user authenticating section 1001 when the entry image synthesizing section 104 requests access monitors of the systems to acquire the content.

Timers 1003 and 1006 are connected to inform of the timing for switching the month to access monitors 109 and 115 of the systems. The accumulated access frequencies 1004 and 1007 are recorded in each system of the user respectively. The system access frequency in this month of each user is recorded in the accumulated access frequency. The access monitor 109 or 115 adds 1 to the accumulated access frequency that is corresponding to the identifier of a user when the access monitor 109 or 115 receives a content acquisition request from the entry image synthesizing section 104. The minimum access frequency value that is required to display the content on the portal entry image is registered in the minimum access frequencies 1005 and 1008.

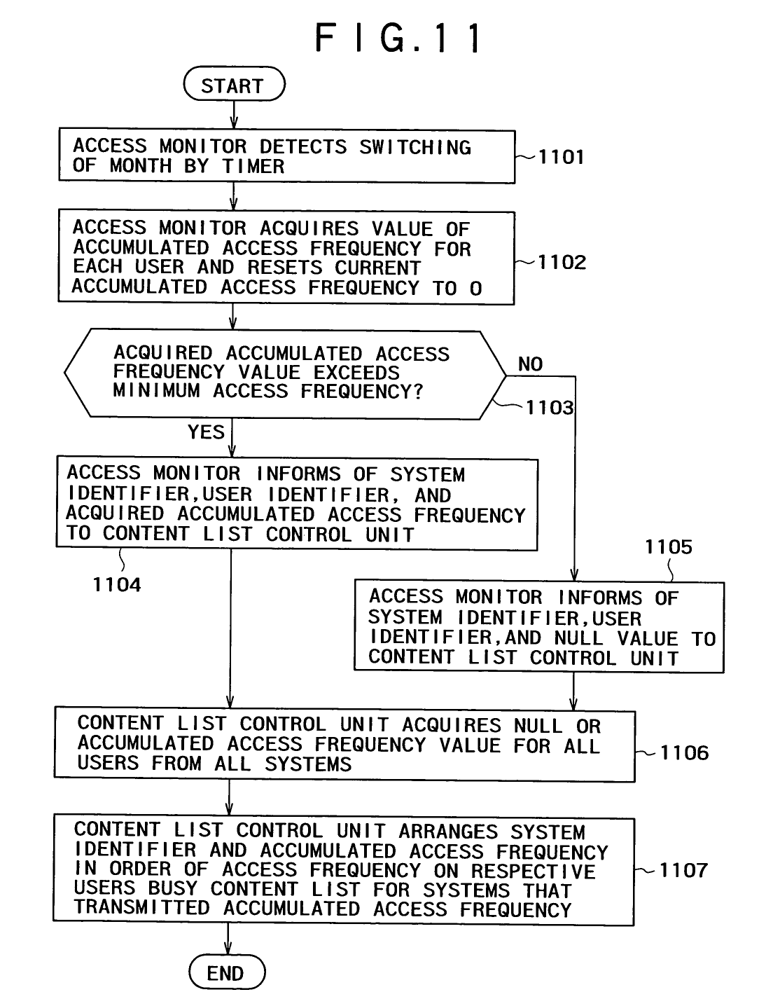

Operation of the access monitors 109 and 115 and the content list controlling section 106 of the system shown in FIG. 10 will be described with reference to a flowchart shown in FIG. 11. Operation of the system 108 is described exemplarily herein. The timer 1003 detects switching of the month (step 1101). The access monitor 109 acquires the accumulated access frequency 1004 value of all the users, and changes the current accumulated access frequency value to 0 (step 1102). If the acquired accumulated access frequency value exceeds the minimum access frequency 1005 of the system, the sequence proceeds to step 1104. On the other hand, if the acquired accumulated access frequency value does not exceeds the minimum access frequency 1005 of the system, the sequence proceeds to step 1105 (step 1103).

The access monitor 109 informs of the system identifier, user identifier, and acquired accumulated access frequency value to the content list controlling section 106 (step 1104). The access monitor 109 informs of the system identifier, user identifier, and value of NULL to the content list controlling section 106. At that time, the value of NULL may be an arbitrary value that is not confusable with the accumulated access frequency value (step 1105).

The content list controlling section 106 acquires NULL or accumulated access frequency value from all the systems for all the users (step 1106). The content list controlling section 106 registers identifiers and accumulated access frequencies of systems that transmit not NULL but accumulated access frequency in the order of access frequency from the top in the busy contents list 1002 (step 1107).

According to the abovementioned embodiment, the access frequency of each content on the portal entry image is measured for each user, and contents are arranged in the order of access frequency from the top. The portal entry image is synthesized so that the layout does not include contents of less access frequency. As the result, the time required to generating contents of less access frequency and the time required to synthesize the portal entry image can be omitted, and access to contents of more access frequency is made easy.

Some embodiments are described hereinabove, but it is understood that various changes and modifications may be made in the invention without departing from the spirit and scope thereof.

According to the present invention, an entry image is generated so that the busy content can be viewed and displayed preferentially in comparison with other contents, and the portal entry image that is used by users easily is displayed.

Entry image synthesis of contents that are unnecessary for users is omitted, and the time required to generate the portal entry image is shortened as a whole.

What is claimed is:

1. A method for generating a portal entry image, comprising the steps of:
generating a first image including a plurality of contents available to be displayed in this image, obtained from a plurality of systems connected to a network (first mode);
generating a second image including busy contents, corresponding to a system selected from among the plurality of systems, whose number being less than that displayed in the first image (second mode);
implementing switching between the first mode and the second mode depending on the information related to the busyness of the contents of the plurality of systems; and
implementing transmitting the first image or the second image to the network.

2. The method according to claim 1, wherein each system monitors the busyness of its own content and, depending on the monitored result, changes the content to be included in the second image.

3. The method according to claim 1, wherein the second image is generated such that the content of a high busyness system is displayed larger than that of low busyness systems.

4. The method according to claim 1, wherein content busyness information is obtained through measurement of the number of connections established in each system.

5. The method according to claim 1, wherein the content busyness information is obtained based on the frequency of requests for the content from each system.

6. The method according to claim 1, wherein the content busyness information is obtained based on the frequency of operations for obtaining the content through the portal entry image.

7. The method according to claim 1, wherein a link for changing current display to the first image is included in the second image.

8. A method for generating a portal entry image, comprising steps of:
generating a first image including a plurality of contents available to be displayed in this image, obtained from a plurality of systems connected to a network (first mode); and
generating a second image including busy contents, corresponding to a system selected from among the plurality of systems, whose number being less than that displayed in the first image (second mode),
wherein the method further comprises the steps of:
generating the second image such that when access frequency of the content of a certain system is determined to be high, the second mode is selected, and that the contents of the busy access frequency are synthesized so as to be included in the second image; and
transmitting the thus generated first or second image for portal entry image through a network to thereby display them on a browser.

9. The method according to claim 8, wherein the portal entry image runs on the first mode in default setting, and the mode is ready to be switched to the second mode depending on a user's access frequency to the content.

10. A portal image generation system having a plurality of systems, each of which has a content generating section, and a server, connected to the systems, for generating a portal entry image to thereby provide the content on a browser through a network, each of the plurality of systems comprising a monitor for measuring the busyness, and
the server comprising
a busy contents list for recording the busy content,
a content list controlling section for updating the content of the busy contents list based on the information of the busyness measured through the monitor, and
an entry image synthesizing section for synthesizing the busy content preferentially according to the content of the busy contents list to thereby generate a portal entry image.

11. A portal image generation system having a server, connected to a plurality of systems generating contents, for generating a portal entry image to thereby provide the content on a browser through a network, the portal image generation system comprising:
a memory means for storing the information of the content;
a controlling section for updating the content of the memory means based on the busyness information transmitted from the plurality of systems; and
an entry image synthesizing section for synthesizing the busy content preferentially based on the memory content of the memory means to thereby generate a portal entry image.

12. The system according to claim 11, wherein the entry image synthesizing section synthesizes the busy content so as to be displayed larger than other contents to thereby generate an image.

13. The system according to claim 11, wherein the entry image synthesizing section is configured so as not to use low busyness contents for synthesizing an image.

14. The system according to claim 11, wherein the entry image synthesizing section generates a portal entry image such that a plurality of contents is arranged in descending order of busyness before synthesizing an image.

15. A portal image generation system having a server, connected to a plurality of systems generating contents, for generating a portal entry image to thereby provide the content on a browser through a network, the server comprising:
a registration content list for registering the layout of the portal entry image including a content to be displayed within a predetermined time period;
a current content list for recording the layout of currently used portal entry image;
an entry image synthesizing section for generating a predetermined content based on the current content list; and
a content list controlling section for updating the current content list depending on lapse in time.

16. A portal image generation system having a server, connected to a plurality of systems generating contents, for generating a portal entry image to thereby provide the content on a browser through a network, the portal entry image generation system comprising:
a user authenticating section for specifying a user of a portal entry image;
a busy contents list for recording on a system-by-system basis the minimum access frequency for displaying the content on the portal entry image, recording on a user-by-user basis the accumulated access frequency for the system, and recording on a user-by-user basis the busy content;
an access monitor for updating the accumulated access frequency value for a user's access to acquire the accumulated access frequency value at intervals;
a content list controlling section for updating the content of the busy contents list based on the busyness acquired through the access monitor; and
an entry image synthesizing section for synthesizing a busy content based on the busy contents list.

17. A method for generating a portal entry image, comprising the steps:
generating a first image including a plurality of contents available to be displayed in this image, obtained from a plurality of systems connected to a network (first mode);
generating a second image including busy contents, corresponding to a system selected from among the plurality of systems, whose number being less than that displayed in the first image (second mode);
selecting the first mode or the second mode; and
transmitting the first or second image for portal entry image, generated in the respective modes, through a network to thereby display them on a browser.
